(19) United States
(12) Patent Application Publication
(10) Pub. No.: US 2015/0053172 A1
(43) Pub. Date: Feb. 26, 2015

(54) DIESEL COMBUSTION SYSTEM

(71) Applicant: Dalian University of Technology, Dalian (CN)

(72) Inventors: Wuqiang LONG, Dalian (CN); Kunpeng QI, Dalian (CN); Jiangping TIAN, Dalian (CN); Qiang ZHANG, Dalian (CN); Kai SHENG, Dalian (CN); Ping YI, Dalian (CN); Yicong WANG, Dalian (CN); Yao FU, Dalian (CN)

(21) Appl. No.: 14/529,187

(22) Filed: Oct. 31, 2014

Related U.S. Application Data
(63) Continuation-in-part of application No. PCT/CN2013/000574, filed on May 15, 2013.

(30) Foreign Application Priority Data
May 16, 2012 (CN) 201210152367.6

(51) Int. Cl. F02M 29/00; F02F 3/24; F02B 1/12

(52) U.S. Cl. CPC F02M 29/00; F02B 1/12; F02F 3/24
USPC 123/298

(57) ABSTRACT

A diesel combustion system including an injector and a combustion chamber. The combustion chamber is formed by a cylinder head, a cylinder liner, and a piston. The combustion chamber includes an upper layer and a lower layer. The diameter D1 of the upper layer is larger than the diameter D2 of the lower layer. A junction of the upper layer and the lower layer is provided with an impinging block for rebounding the diesel fuel spray. The impinging block includes an impinging surface, an upper guide surface, and a lower guide surface. When in use, part of the diesel fuel spray is rebounded by the impinging surface, and part of the diesel fuel spray is diffused along the upper guide surface and the lower guide surface of the impinging block to achieve double-layered split flow of the diesel fuel.

### CROSS-REFERENCE TO RELATED APPLICATIONS

This application is a continuation-in-part of International Patent Application No. PCT/CN2013/000574 with an international filing date of May 15, 2013, designating the United States, now pending, and further claims priority benefits to Chinese Patent Application No. 201210152367.6 filed May 16, 2012. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND OF THE INVENTION

1. Field of the Invention

The invention relates to the mixture formation and combustion in an engine, and more particularly to a diesel combustion system comprising a double-layered combustion chamber.

2. Description of the Related Art

In general, air/fuel mixture is unevenly distributed along the circumferential direction in a direct injection diesel engine. The sprayed diesel fuel mist tends to accumulate in the vicinity of the point of fall thereby producing an over-rich area, or to be closely attached to the wall of the combustion chamber thereby forming a diesel fuel film. As a result, even if the diesel engine has a large excess air ratio, it has low air utilization ratio, incomplete combustion, high diesel fuel consumption, and high soot emission.

### SUMMARY OF THE INVENTION

In view of the above-described problems, it is one objective of the invention to provide a diesel combustion system that has a double-layered combustion chamber. The double-layered combustion chamber narrows the space between the top of the piston and the bottom of the cylinder head. Part of the diesel fuel spray is rebounded by an impinging surface, and part of the diesel fuel spray is diffused along an upper guide surface and a lower guide surface of an impinging block whereby achieving double-layered split flow of the diesel fuel spray and the second atomization of the diesel fuel. The diesel combustion system of the invention has high air utilization ratio and excellent atomization performance.

To achieve the above objective, in accordance with one embodiment of the invention, there is provided a diesel combustion system comprising an injector and a combustion chamber. The combustion chamber is formed by a cylinder head, a cylinder liner, and a piston. The combustion chamber comprises an upper layer and a lower layer, and a diameter D1 of the upper layer is larger than a diameter D2 of the lower layer. A junction of the upper layer and the lower layer is provided with an impinging block. The impinging block comprises an impinging surface, an upper guide surface, and a lower guide surface; part of the diesel fuel spray is rebounded by the impinging surface, and part of the diesel fuel spray is diffused along the upper guide surface and the lower guide surface of the impinging block whereby achieving double-layered split flow of the diesel fuel.

In a class of this embodiment, the impinging surface of the impinging block comprises a conical surface, a first upper transition curved surface, and a first lower transition curved surface.

In a class of this embodiment, the impinging surface of the impinging block comprises a curved surface, a second upper transition curved surface, and a second lower transition curved surface.

In a class of this embodiment, the impinging surface of the impinging block comprises an upper curved surface and a lower curved surface.

In a class of this embodiment, the upper guide surface of the impinging block comprises a first upper guide flat surface.

In a class of this embodiment, the upper guide surface of the impinging block comprises a first upper guide annular surface and a second upper guide flat surface.

In a class of this embodiment, the upper guide surface of the impinging block comprises a first upper guide annular surface and a second upper guide annular surface.

In a class of this embodiment, the upper guide surface of the impinging block comprises an upper guide annular surface.

In a class of this embodiment, the lower guide surface of the impinging block comprises a first lower guide annular surface and a second lower guide annular surface.

In a class of this embodiment, the lower guide surface of the impinging block comprises a first lower guide conical surface and a second lower guide annular surface.

In a class of this embodiment, the lower guide surface of the impinging block comprises a third lower guide annular surface.

In summary, the impinging surface of the impinging block can adopt at least three technical solutions, that is, a conical surface, an annular surface, and a combination of two curved surfaces.

The upper guide surface of the impinging block can adopt at least four technical solutions, that is, a flat surface, a combination of an annular surface and a flat surface, a combination of two annular surfaces, and an annular surface.

The lower guide surface of the impinging block can adopt at least three technical solutions, that is, a combination of two annular surfaces, a combination of a conical surface and an annular surface, and an annular surface.

The impinging surface, the upper guide surface, and the lower guide surface can be arbitrarily combined to form an impinging block having different shapes.

In the process of spraying diesel fuel, the diesel fuel spray impinges against the impinging block. Part of the diesel fuel spray is rebounded by the impinging surface, and part of the diesel fuel spray is diffused along the upper guide surface and the lower guide surface of the impinging block whereby achieving double-layered split flow of the diesel fuel spray. The diffused diesel fuel occupies a large volume, and is not attached to the chamber wall, so that a large amount of air is involved, whereby forming a uniform gas mixture rapidly.

Advantages according to embodiments of the invention are summarized as follows: the direct injection diesel combustion system has a double-layered combustion chamber. The diesel fuel spray from the injector is sprayed and impinges against the impinging block. Part of the diesel fuel spray is rebounded by the impinging surface, and part of the diesel fuel spray is diffused along the upper guide surface and the lower guide surface of an impinging block whereby achieving double-layered split flow of the diesel fuel spray. As a result, the accumulation of the diesel fuel spray in the vicinity of the point of fall is prevented, the diesel fuel diffusion velocity is increased, and the air entrainment is increased, all of which facilitate the formation of the gas mixture, and improve the combustion performance and emission performance of the diesel engine. Under rated working conditions, in contrast to conventional diesel combustion system, the fuel consumption of the direct injection diesel combustion system comprising a double-layered combustion chamber is decreased by 3%, and the smoke emission is decreased by 50%.

### BRIEF DESCRIPTION OF THE DRAWINGS

The invention is described hereinbelow with reference to the accompanying drawings, in which:

FIG. 1 is a schematic diagram of a diesel combustion system comprising a double-layered combustion chamber in accordance with one embodiment of the invention;

FIG. 2 is an enlarged view of part II in FIG. 1;

FIG. 3 is a schematic diagram of an impinging surface of an impinging block in accordance with one embodiment of the invention;

FIG. 4 is another schematic diagram of an impinging surface of an impinging block in accordance with one embodiment of the invention;

FIG. 5 is a schematic diagram of an upper guide surface of an impinging block in accordance with one embodiment of the invention;

FIG. 6 is another schematic diagram of an upper guide surface of an impinging block in accordance with one embodiment of the invention;

FIG. 7 is another schematic diagram of an impinging surface of an impinging block in accordance with one embodiment of the invention;

FIG. 8 is a schematic diagram of a lower guide surface of an impinging block in accordance with one embodiment of the invention; and

FIG. 9 is another schematic diagram of a lower guide surface of an impinging block in accordance with one embodiment of the invention.

In the drawings, the following reference numbers are used: 1. Cylinder head; 2. Cylinder liner; 3. Piston; 3a. Top of piston; 4. Combustion chamber; 5. Injector; 6. Diesel fuel spray; 7. Impinging block; 8. Upper layer; 9. Lower layer; 10. Conical surface; 10a. First upper transition curved surface; 10b. First lower transition curved surface; 11. Curved surface; 11a. Second upper transition curved surface; 11b. Second lower transition curved surface; 12a. Upper curved surface; 12b. Lower curved surface; 13. First lower guide annular surface; 14. Second lower guide annular surface; 15. First upper guide flat surface; 16. First upper guide annular surface; 17. Second upper guide flat surface; 18. Second upper guide annular surface; 19. Upper guide annular surface; 20. First lower guide conical surface; 21. Third lower guide annular surface.

### DETAILED DESCRIPTION OF THE EMBODIMENTS

For further illustrating the invention, experiments detailing a diesel combustion system comprising a double-layered combustion chamber are described below. It should be noted that the following examples are intended to describe and not to limit the invention.

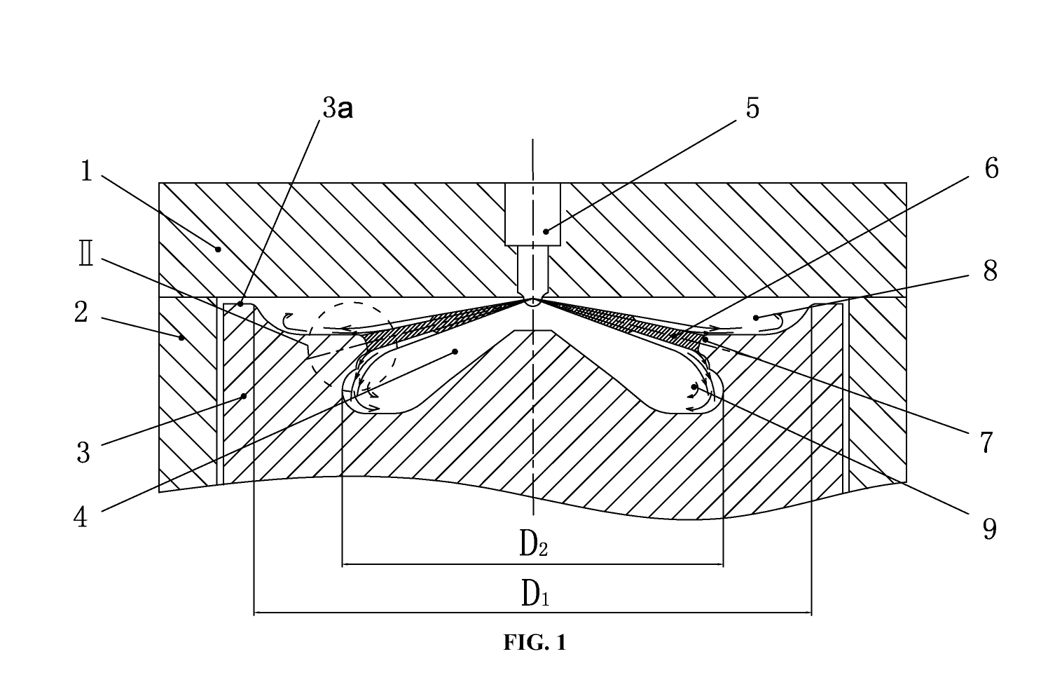

As shown in FIG. 1, a direct injection diesel combustion system comprises an injector 5 and a combustion chamber 4. The combustion chamber is formed by a cylinder head 1, a cylinder liner 2, and a piston 3. The injector 5 is configured to inject high pressure diesel fuel into the combustion chamber 4. The combustion chamber comprises an upper layer 8 and a lower layer 9, and a diameter D1 of the upper layer is larger than a diameter D2 of the lower layer. A junction of the upper layer and the lower layer is provided with an impinging block 7. The impinging block 7 comprises an impinging surface, an upper guide surface, and a lower guide surface. Part of the diesel fuel spray is rebounded by the impinging surface, and part of the diesel fuel spray is diffused along the upper guide surface and the lower guide surface of the impinging block whereby achieving double-layered split flow of the diesel fuel spray. As a result, the diffused diesel fuel occupies a large volume, and is not attached to the chamber wall, so that a large amount of air is entrained, which accelerates the formation of a uniform gas mixture. Because the upper layer of the combustion chamber has a relatively large diameter, the space between the top 3a of the piston and the bottom of the cylinder head is narrowed, so that the air in the two layers of the combustion chamber is fully mixed with diesel fuel to form a uniform gas mixture rapidly. Experiments show that, under rated working conditions, in contrast to conventional diesel combustion system, the diesel fuel consumption of the direct injection diesel combustion system comprising a double-layered combustion chamber is decreased by 3%, and the smoke emission is decreased by 50%.

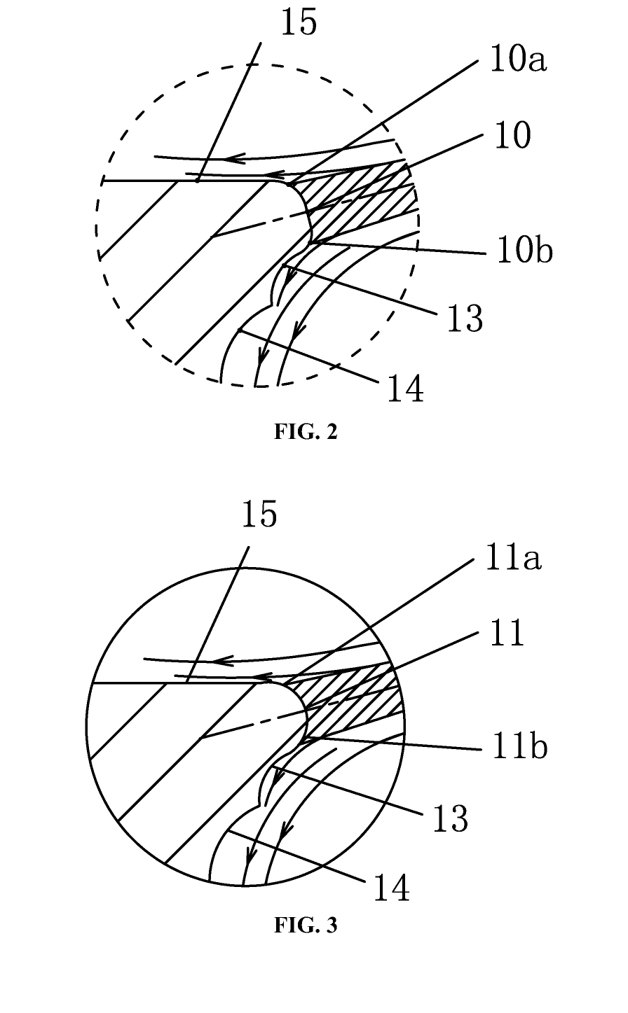

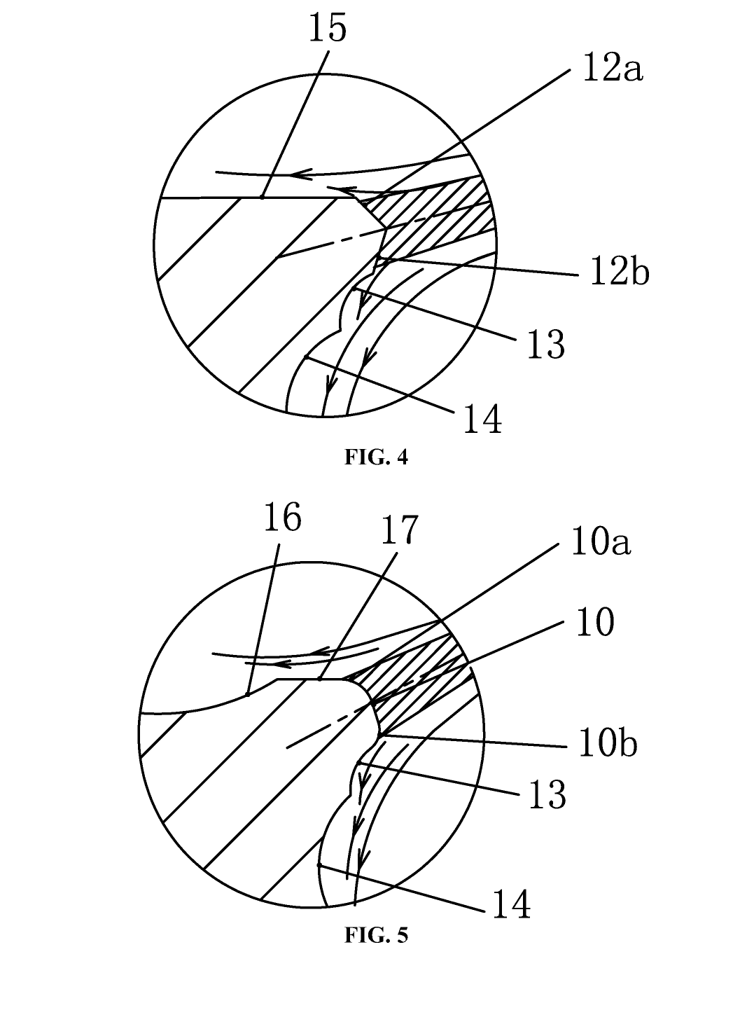

FIGS. 2-4 illustrate the shapes of the impinging surface of the impinging block 7. Specifically, in FIG. 2, the impinging surface of the impinging block comprises a conical surface 10, a first upper transition curved surface 10a, and a first lower transition curved surface 10b. In FIG. 3, the impinging surface of the impinging block comprises a curved surface 11, a second upper transition curved surface 11a, and a second lower transition curved surface 11b. In FIG. 4, the impinging surface of the impinging block comprises an upper curved surface 12a and a lower curved surface 12b.

In the process of diesel fuel injection, the diesel fuel spray 6 from the injector 5 impinges against the impinging block. Part of the diesel fuel spray is rebounded by the impinging surface, and part of the diesel fuel spray is diffused along the upper guide surface and the lower guide surface of the impinging block whereby achieving double-layered split flow of the diesel fuel spray.

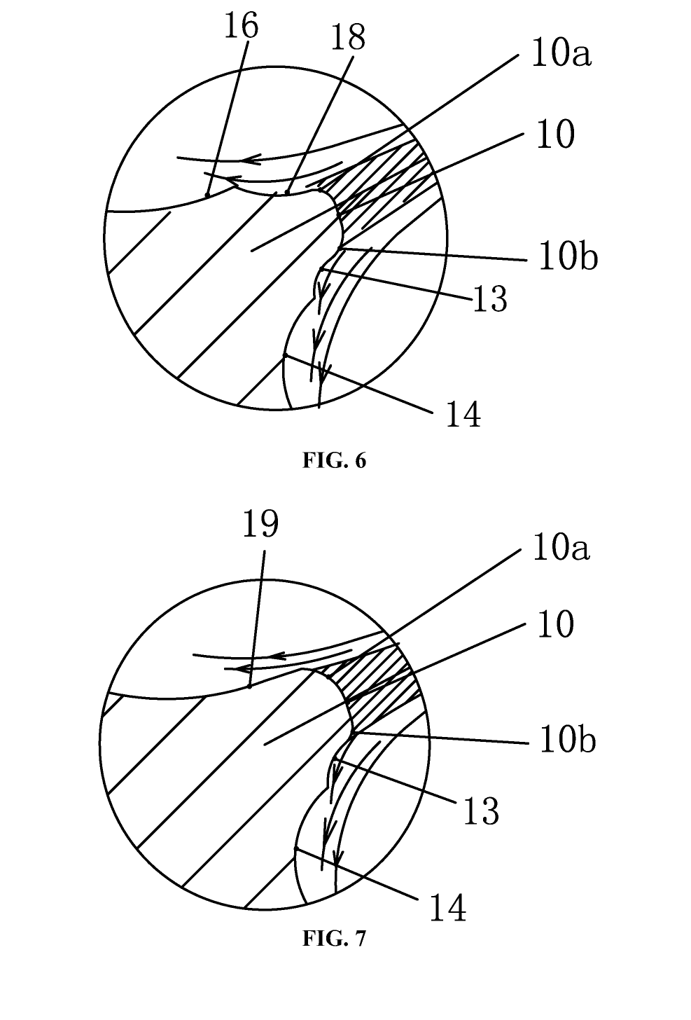

FIGS. 2 and 5-7 illustrate the shapes of the upper guide surface of the impinging block of the impinging block. Specifically, in FIG. 2, the upper guide surface of the impinging block comprises a first upper guide flat surface 15. In FIG. 5, the upper guide surface of the impinging block comprises a first upper guide annular surface 16 and a second upper guide flat surface 17. In FIG. 6, the upper guide surface of the impinging block comprises a first upper guide annular surface 16 and a second upper guide annular surface 18. In FIG. 7, the upper guide surface of the impinging block comprises an upper guide annular surface 19.

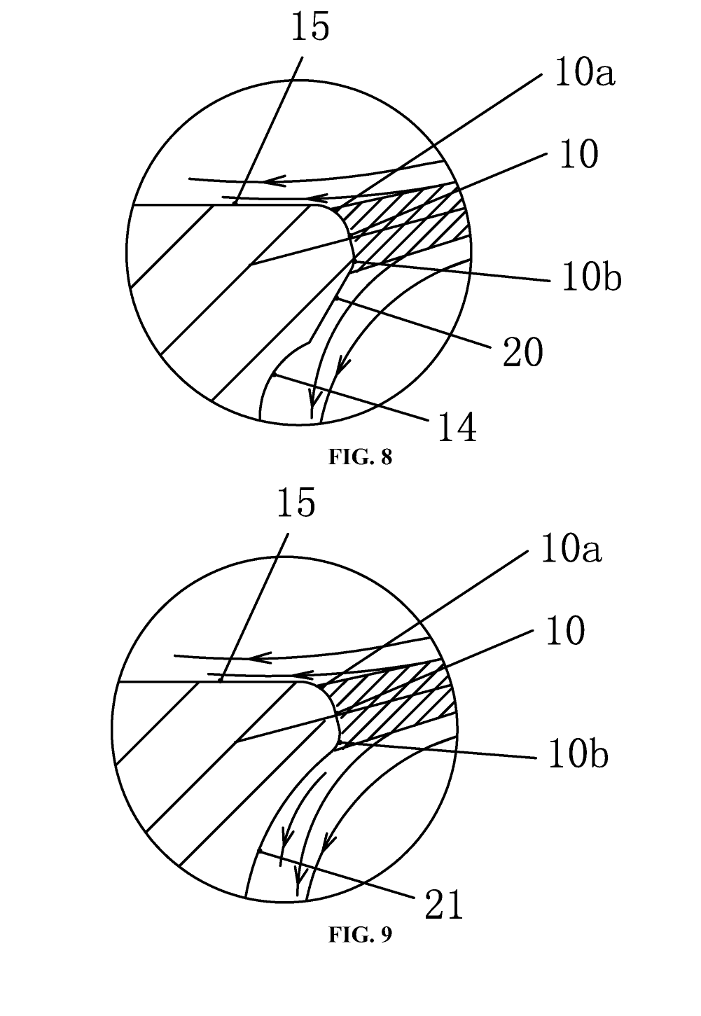

FIGS. 2 and 8-9 illustrate the shapes of the lower guide surface of the impinging block of the impinging block. Specifically, in FIG. 2, the lower guide surface of the impinging block comprises a first lower guide annular surface 13 and a second lower guide annular surface 14. In FIG. 8, the lower guide surface of the impinging block comprises a first lower guide conical surface 20 and a second lower guide annular surface 14. In FIG. 9, the lower guide surface of the impinging block comprises a third lower guide annular surface 21.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A diesel combustion system, comprising an injector and a combustion chamber, the combustion chamber being formed by a cylinder head, a cylinder liner, and a piston, wherein
the combustion chamber comprises an upper layer and a lower layer, and a diameter D1 of the upper layer is larger than a diameter D2 of the lower layer;
a junction of the upper layer and the lower layer is provided with an impinging block;
the impinging block comprises an impinging surface, an upper guide surface, and a lower guide surface;
part of the diesel fuel spray is rebounded by the impinging surface, and part of the diesel fuel spray is diffused along the upper guide surface and the lower guide surface of the impinging block whereby achieving double-layered split flow of the diesel fuel spray.

2. The diesel combustion system of claim 1, wherein the impinging surface of the impinging block comprises a conical surface, a first upper transition curved surface, and a first lower transition curved surface.

3. The diesel combustion system of claim 1, wherein the impinging surface of the impinging block comprises a curved surface, a second upper transition curved surface, and a second lower transition curved surface.

4. The diesel combustion system of claim 1, wherein the impinging surface of the impinging block comprises an upper curved surface and a lower curved surface.

5. The diesel combustion system of claim 1, wherein the upper guide surface of the impinging block comprises a first upper guide flat surface.

6. The diesel combustion system of claim 1, wherein the upper guide surface of the impinging block comprises a first upper guide annular surface and a second upper guide flat surface.

7. The diesel combustion system of claim 1, wherein the upper guide surface of the impinging block comprises a first upper guide annular surface and a second upper guide annular surface.

8. The diesel combustion system of claim 1, wherein the upper guide surface of the impinging block comprises an upper guide annular surface.

9. The diesel combustion system of claim 1, wherein the lower guide surface of the impinging block comprises a first lower guide annular surface and a second lower guide annular surface.

10. The diesel combustion system of claim 1, wherein the lower guide surface of the impinging block comprises a first lower guide conical surface and a second lower guide annular surface.

11. The diesel combustion system of claim 1, wherein the lower guide surface of the impinging block comprises a third lower guide annular surface.
